(19) United States
(12) Patent Application Publication
(10) Pub. No.: US 2012/0253735 A1
(43) Pub. Date: Oct. 4, 2012

(54) Method and apparatus for operating a motor with optimized efficiency

(75) Inventors: Roderick A. Hyde, Redmond, WA (US); Jordin T. Kare, Seattle, WA (US); Thomas A. Weaver, San Mateo, CA (US); Lowell L. Wood, JR., Bellevue, WA (US)

(73) Assignee: SEARETE LLC, BELLEVUE, WA (US)

(21) Appl. No.: 13/065,759

(22) Filed: Mar. 29, 2011

(51) Int. Cl. G06F 15/00; F25B 1/00; H02K 9/00; F25B 21/02; F25B 21/00; F28D 15/00; F25B 17/00

(52) U.S. Cl. 702/130; 165/104.19; 62/498; 62/476; 62/3.2; 62/3.1; 310/53

(57) ABSTRACT

A system and method can include a motor subject to a change in efficiency as a function of temperature and a motor cooling system. The motor cooling system can be driven to minimize the sum of energy consumed by the motor and the cooling system.

### SUMMARY

According to an embodiment, a cooled motor includes a motor subject to a change in efficiency as a function of temperature and a motor cooling apparatus configured to variably cool the motor. The motor cooling apparatus can variably cool the motor such that a combination of a motor efficiency energy loss and a motor cooling apparatus energy consumption is minimized compared to a non-zero motive energy output.

According to an embodiment, a motor and cooler system includes a motor, a cooler configured to cool the motor or the motor windings according to a variable cooler energy consumption and corresponding variable thermodynamic cooling energy, and a cooler drive or coupling configured to minimize the sum of a motor energy consumption plus the cooler energy consumption, and the sum divided by a motor output energy greater than zero.

According to an embodiment, a motor and cooler drive includes a variably cooled motor and a cooler drive or cooler coupling configured to maximize a system efficiency equal to a motive energy output divided by a sum of a motor energy consumption plus a cooling energy consumption.

According to an embodiment, a system for cooling a motor includes a motor cooling apparatus configured to cool a motor and a controller including an interface configured to receive a parameter corresponding to, or predictive of, a motor operational value, the controller being operatively coupled to the motor cooling apparatus and configured to drive the motor cooling apparatus to minimize a sum of energy consumed by the motor plus energy consumed by the motor cooling apparatus.

According to an embodiment, a method for operating a motor includes driving a motor to produce a specified motor performance and driving a motor cooling apparatus to minimize a sum of energy consumed by the motor plus energy consumed by the motor cooling apparatus. The method can further include receiving at least a first parameter corresponding to or predictive of a temperature of the motor and determining a motor cooling apparatus drive parameter responsive to the parameter(s).

According to an embodiment, a computer method for determining optimized cooling of a motor includes receiving at least a first parameter corresponding to or predictive of an operational value of a motor and determining with a computer at least a second parameter corresponding to driving a motor cooling apparatus as a function of the first parameter. The second parameter is selected to minimize a combination of energy consumed by the motor cooling apparatus plus energy lost by motor inefficiency corresponding to the operational value.

According to an embodiment, a non-transitory computer readable medium carries computer instructions configured to cause a computer to execute steps including receiving first data corresponding to a current or future motor operational value and determining second data corresponding to, for a specified motor output, driving a motor cooling apparatus to maximize combined energy efficiency of the motor and the motor cooling apparatus.

### BRIEF DESCRIPTION OF THE FIGURES

FIG. 1 is a block diagram of a cooled motor, according to an embodiment.

FIG. 2A is a graph showing, for a first operating condition, a relationship between motor energy consumption, cooling apparatus energy consumption, and total energy consumption, according to an embodiment

FIG. 2B is a graph showing a relationship between motor energy consumption, cooling apparatus energy consumption, and total energy consumption for a second operating condition, according to an embodiment.

FIG. 3 is a block diagram of a cooled motor arranged to include a coupling between the motor and at least a portion of a motor cooling apparatus, according to an embodiment.

FIG. 4 is a block diagram of a controller configured to drive a motor cooler responsive to parameter input according to a schedule that results in minimized total energy consumption, according to an embodiment.

FIG. 5 is a flow chart showing a method for operating a motor cooling apparatus (and optionally a motor) to maximize efficiency, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here.

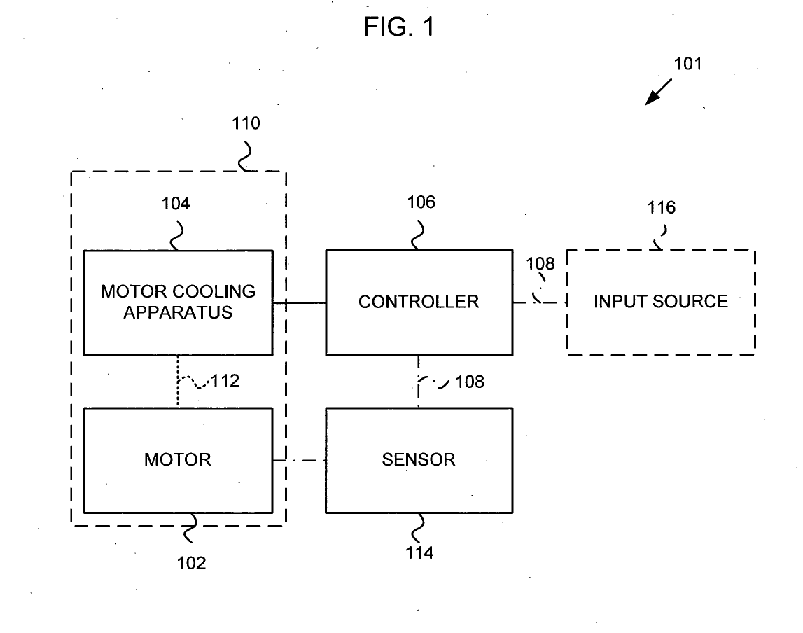

FIG. 1 is a block diagram of a cooled motor 101, according to an embodiment. The cooled motor 101 can include a motor 102 subject to a change in efficiency as a function of temperature and a motor cooling apparatus 104 configured to variably cool the motor. According to embodiments, the motor cooling apparatus 104 can provide an amount of cooling that is optimized such that a combination of a motor efficiency energy loss and a motor cooling apparatus energy consumption is minimized (for to a non-zero motive energy output).

The motor 102 can be an electric motor such as an AC induction motor, a universal motor, an AC synchronous motor, a DC stepper motor, a DC brushless motor, a DC brushed motor, or a pancake DC motor, for example. The motor can be subject to a change in efficiency as a function of temperature because of an increase in electrical resistance at relatively high temperatures of a portion of the motor. For example, the motor can be subject to an increase in electrical resistance of motor windings at higher temperatures.

The motor cooling apparatus 104 can include one or more of a fan, a circulating liquid, a phase-change fluid, a vapor-compression refrigeration device, a vapor-absorption refrigeration device, Peltier-effect device, or a caloric effect device, for example. Optionally, the motor 102 and the motor cooling apparatus 104 can be configured as a cooled motor assembly 110. Cooling is provided from the motor cooling apparatus 104 to the motor 102 according to various functional relationships, referenced generically as a cooling action 112. For example, the cooling action can 112 occur via circulation of a liquid through the motor 102, via a gas blown over portions of the motor 104 to provide convective cooling, or via conduction of excess heat through a heat sink.

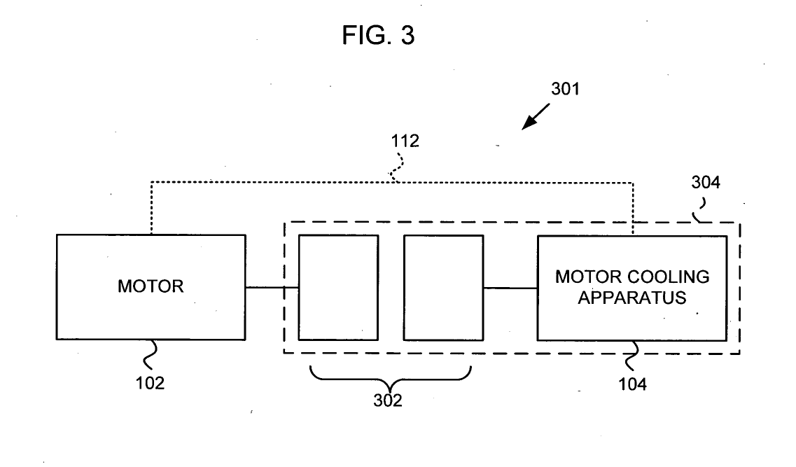

The motor cooling apparatus 104 can be configured to apply variable cooling to the motor 102 as a function of a motor operational value and/or a temperature of at least a portion of the motor. Various approaches can be used to drive the motor cooling apparatus 104. In one embodiment, illustrated in FIG. 3, a variable coupling 302 can selectively couple motor output power to a cooling apparatus. According to the embodiment of FIG. 1, an electronic controller 106 can control the motor cooling apparatus 104.

The controller 106 can be configured to receive one or more inputs 108 and control the motor cooling apparatus responsive to the one or more inputs. The inputs may be provided by one or more sensors 114, or one or more other input sources 116, for example. Optionally, the one or more sensors 114 can be integrated as portions of the controller 106. Optionally, the controller 106 can include the one or more input sources 116, or can be integrated into the one or more input sources 116.

For example, the one or more inputs 108 can include one or more of motor temperature, motor winding temperature, or ambient temperature. Alternatively or additionally, the one or more inputs 108 can include one or more of motor torque output, motor torque demand, motor rotational velocity, demanded motor rotational velocity, a motor voltage, a motor current, a motor drive frequency, a battery charge, a power availability, or an incremental energy cost. The one or more inputs 108 can also include one or more of a future motor torque demand or a future demanded motor rotational velocity.

The controller 106, which can be programmable, can include at least two inputs 108 and control the motor cooling apparatus 104 responsive to the at least two inputs 108. The controller 106 can be configured to allow short term non-minimal energy consumption. For example, the controller 106 can be configured to increase motor 102 cooling in anticipation of future motor use. If the input source 116 is configured to provide an input 108 corresponding to an upcoming increase in torque demand, then the controller 106 may increase the energy consumed by the motor cooling apparatus 104 in anticipation of the increased torque demand. This can increase total energy consumed by the motor 102 and the motor cooling apparatus 104 for a short time, but then reduce total energy consumed after the increased torque demand is realized.

According to embodiments, the variable cooling applied by the motor cooling apparatus 104 is not directly proportional to motor rotational velocity and/or not directly proportional to temperature.

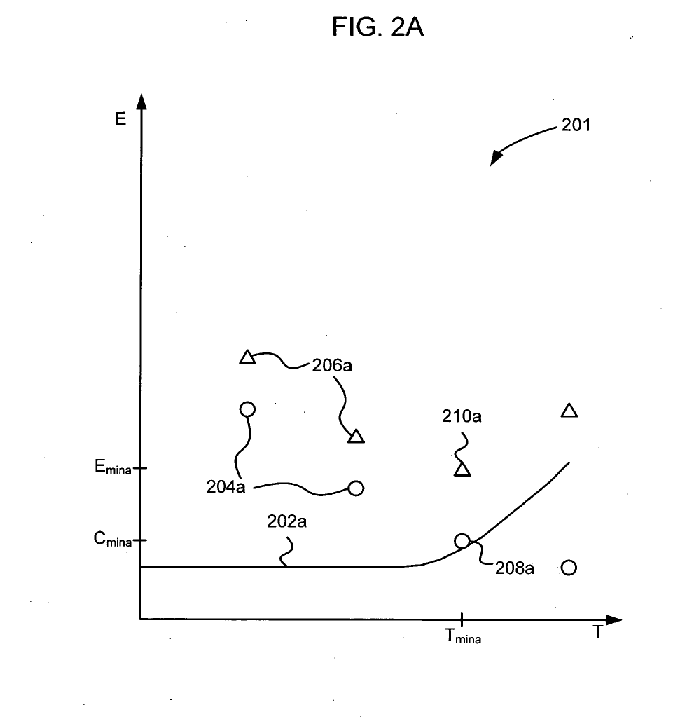

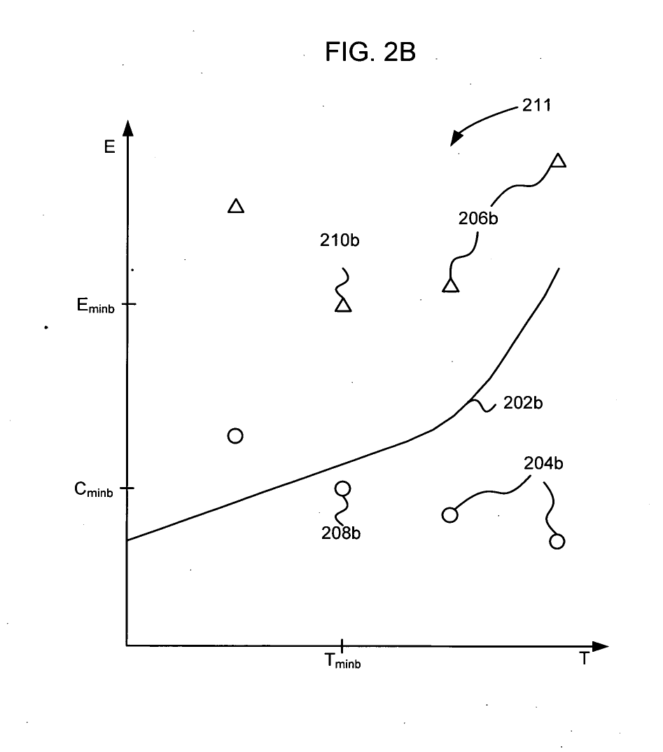

FIG. 2A is an illustrative graph showing, for a first operating condition 201, a relationship between motor energy consumption 202a, motor cooling apparatus energy consumption 204a, and total energy consumption 206a as a function of temperature, such as motor winding temperature. Optionally, the x-axis can correspond to motor temperature (such as case temperature), motor winding temperature, or ambient temperature. For example, the operating characteristic 201 of FIG. 2A can correspond to characteristic energy consumption curves for a particular motive power output at a particular ambient temperature. Alternatively, the relationship between motor energy consumption, motor cooling apparatus energy consumption, and total energy consumption can be shown as a function of a parameter other than temperature. More generally, the X-axis can correspond to any of several temperature measurements. The set of curves (e.g. FIG. 2A vs. FIG. 2B) can correspond to a set of motor operating levels or functions of motor operating levels.

In the illustrative example 201, it can be seen that, for the given operating condition, the motor consumes relatively constant energy at relatively low winding temperature T, and then (at the same ambient temperature and motive power output), the motor energy consumption 202a rises with temperature as resistance in the motor windings begins to increase as a function of temperature.

Cooling apparatus energy consumption 204a is shown as the amount of energy consumed by the cooling apparatus to cool the motor windings to various temperatures T, with the motor cooling apparatus requiring more energy to cool the windings to lower temperatures. Cooling apparatus energy consumption 204a is shown as a discontinuous function, indicated by discrete circles, such that four different cooler settings result in four discrete maintained winding temperatures. Such a discontinuous function can be a result, for example, of successively adding more cooling stages or more cooling apparatuses, can result from discrete cooler duty cycles (in which case the horizontal axis may be viewed as an average winding temperature), or can result from discrete control settings available from a controller. Alternatively, cooling apparatus energy consumption 204 can be a continuous function.

The sum of energy consumed 206a is also shown as a discontinuous function, indicated by discrete triangles. For a continuous cooling apparatus energy consumption function, the sum of energy consumed 206a can also be a continuous function. The sum of energy consumed is the mathematical sum of energy E consumed by the motor 202a plus energy consumed by the motor cooling apparatus 204a, as a function of temperature T (or other suitable x-axis). From inspection, it can be seen that the lowest combined energy consumption, Eₘᵢₙₐ occurs at a point 210a corresponding to a temperature Tₘᵢₙₐ and a motor cooling apparatus function 208a. Accordingly, selecting a motor cooling apparatus energy consumption Cₘᵢₙₐ would satisfy the goal of minimizing total energy consumption (and would also satisfy the goal of minimizing total motor and cooling apparatus efficiency losses) under the conditions 201 of FIG. 2A.

As indicated above, the graph of energy consumptions of FIG. 2A corresponds to a first operating condition. FIG. 2B shows energy consumption functions at another operating condition 211. For example, the operating condition 211 of FIG. 2B can correspond to a different motor operating level such as higher torque, higher rotational velocity, etc. Functions 202b, 204b, and 206b respectively correspond to motor energy consumption, cooling apparatus energy consumption, and total energy consumption at the condition 211. As can be seen, the motor energy consumption 202b is a stronger function of winding temperature T at condition 211 than it was at condition 201. It can also be seen that the cooling apparatus can require more energy E to maintain the various motor winding temperatures. In the case of FIG. 2B, the minimum combined energy consumption occurs at a point 210b corresponding to a total energy consumption E_{minb}. To reach this minimum total energy consumption, the cooling apparatus is operated at a point 208b on its energy consumption function corresponding to a cooling apparatus energy consumption of C_{minb} and a temperature T_{minb}.

It can be seen that operating the cooling apparatus at a higher energy consumption results in lower total energy consumption than the case of FIG. 2A. Accordingly, selecting a motor cooling apparatus energy consumption C_{minb} would satisfy the goal of minimizing total energy consumption (and would also satisfy the goal of minimizing total motor and cooling apparatus efficiency losses) under the conditions 211 of FIG. 2B.

Generically, each set of conditions 201, 211 can be referred to as an operational value of the motor. The operational value can include one or more of motor torque output, motor torque demand, motor rotational velocity, demanded motor rotational velocity, a motor voltage, a motor current, a motor drive frequency, a battery charge, a power availability, or an incremental energy cost. The one or more inputs 108 can also include one or more of a future motor torque demand or a future demanded motor rotational velocity.

The combined energy consumption 206a, 206b for each operational value is the sum of the energy consumed by the motor 202a, 202b plus energy consumed by the motor cooling apparatus 204a, 204b. For example, it can be advantageous to allow the motor to operate at a higher temperature under a relatively low load condition, and to operate at a lower temperature under a relatively high load condition, the latter condition providing a larger cooling apparatus energy budget accruing from the greater savings in motor energy consumption.

According to embodiments, the apparatuses described herein can be configured to select or provide motor cooling apparatus operating parameters that cause the motor and motor cooling apparatus to operate at minimum combined energy consumption, shown as Eₘᵢₙₐ and E_{minb}, respectively, for the conditions of FIGS. 2A and 2B.

According to embodiments, the combination of a motor efficiency energy loss and a motor cooling apparatus energy consumption can be minimized compared to other available motor cooling apparatus energy consumptions. In the illustrative examples of FIGS. 2A and 2B, the combined energy consumption 206a, 206b is depicted as a discontinuous function corresponding to discrete, available motor cooling apparatus energy consumptions that are not infinitesimally adjustable. The motor efficiency energy loss and motor cooling apparatus energy consumption can be considered to be minimized when combined energy consumed by the motor and the motor cooling apparatus is less than the combined energy at a different motor cooling apparatus energy consumption. Looked at another way, the motor efficiency energy loss and motor cooling apparatus energy consumption can be considered to be minimized when the sum of energy consumption is less than the sum under conditions of the motor cooling apparatus being driven proportional to motor rotational velocity or the motor cooling apparatus being thermostatically controlled to be on or off. In another aspect, the motor efficiency energy loss and motor cooling apparatus energy consumption can be considered minimized when combined energy consumed by the motor and the motor cooling apparatus is within a tolerance of a potential minimum consumption to achieve the non-zero motive energy output. For example, the tolerance can be 10%. Viewed another way, the combination of a motor efficiency energy loss and a motor cooling apparatus energy consumption is minimized when energy consumed by the motor and motor cooling apparatus is less than second energy consumed by the motor and motor cooling apparatus that is a result of a motor cooling apparatus that is driven with a fixed energy consumption.

Referring to FIG. 3 the cooled motor 301 can be arranged to include a coupling 302 between the motor 102 and at least a portion of the motor cooling apparatus 104, according to an embodiment. The coupling 302 can be configured to variably transfer energy from the motor 102 to the motor cooling apparatus 104 as a function of temperature. The coupling 302 can be configured to vary energy transfer from the motor 102 to the motor cooling apparatus 104. The cooler drive 302 can include a thermostatic or other device coupled between the motor 102 and the motor cooler 104 that progressively engages the motor cooler 104 according to a thermodynamic, fluidic, or other mechanism that results in minimizing total energy consumption. For example, the cooler drive 302 can operate responsive to one or more of a temperature dependent change in thermal conductivity, fluid expansion, solid expansion, change in viscosity, change in pressure, change in volume, or change in friction, for example. Optionally, the coupling 302 can be integral to the cooling apparatus 104 in an assembly 304, as shown. Alternatively, the coupling 302 can be integral to the motor 102. The motor cooling apparatus 104 is configured to cool the motor 102 via an operative coupling 112 that can take many forms, depending on the physical embodiments of the motor cooling apparatus 104 and the motor 102.

Alternatively, the cooler drive can include an electronic controller operable to drive the motor cooler 104 according to programmed logic.

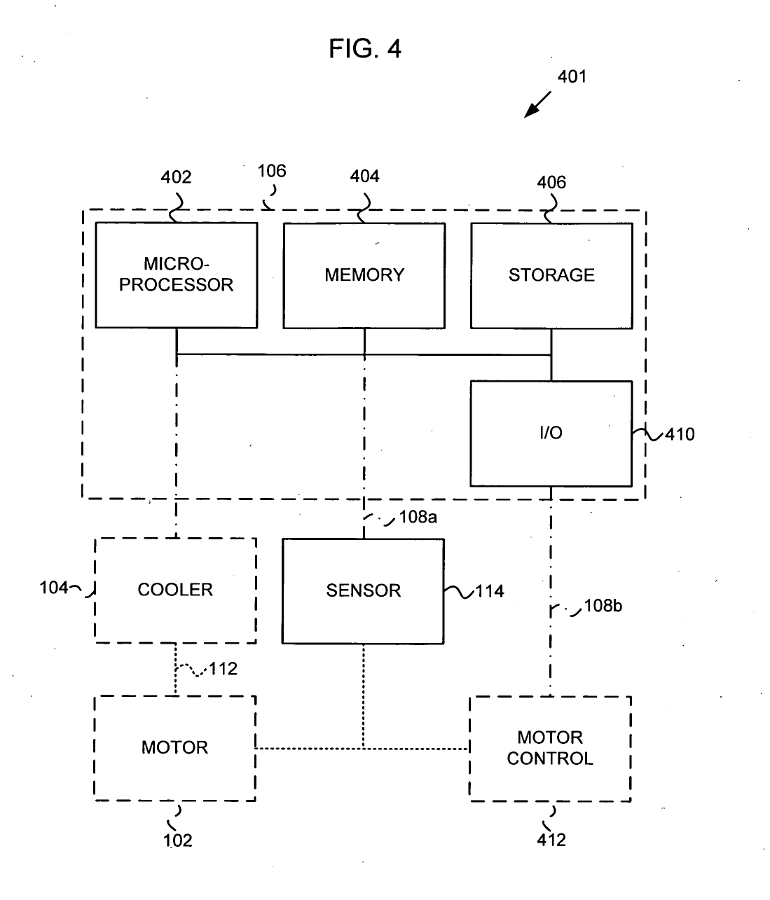

FIG. 4 is a block diagram of a system 401 including a controller 106 configured to drive a motor cooler 104 responsive to parameter input according to a schedule that results in minimized total energy consumption (subject to the broadened definition of “minimum”, given above) of the motor 102 and cooler 104 in combination, according to an embodiment. The controller 106 can include a microprocessor or microcontroller (such as an ARM core, for example) 402 coupled to memory 404 and non-volatile memory or storage 406 such that non-transitory computer-executable instructions held in the storage 406 can cause the microprocessor 402 and memory 404 to cooperatively provide cooler 104 control data or signals responsive to parameter input on parameter input lines 108a, 108b.

For example, one or more parameter input lines 108a can be operatively coupled to one or more sensors 114 that are, in turn, operatively coupled to the motor 102 and/or other sensed conditions such as ambient temperature, weight of a driven apparatus, etc. Optionally, the one or more sensors 114 can be integrated into the controller 106. According to another example, or in combination with the parameter input line 108a, a second parameter input line 108b can be interfaced to the controller 106 via a data interface 410 such as a serial data receiver or transceiver. The data interface 410 can be operatively couple to various sources of parameters. A motor controller 412 can output data or signals corresponding to a motor cooling need or future motor cooling need. Alternatively or additionally, the second data line 108 can sniff control input to the motor controller 412 or motor drive signals output by the motor controller 412.

In combination, the parameter input lines 108a and/or 108b can provide one or more inputs 108 and the controller 106 can control the cooler 104 responsive to the one or more inputs 108. The one or more inputs 108 can include one or more of motor temperature, motor winding temperature, or ambient temperature. The one or more inputs 108 can additionally or alternatively provide motor torque output, motor torque demand, motor rotational velocity, demanded motor rotational velocity, a motor voltage, a motor current, a motor drive frequency, a battery charge, a power availability, and/or an incremental energy cost. Optionally, the one or more inputs 108 can provide a future motor torque demand and/or a future demanded motor rotational velocity.

One or more sensors 114 can include a sensor configured to detect the parameter corresponding to or predictive of the motor temperature. For example, the one or more sensors can include a temperature sensor configured to measure one or more of motor temperature, motor winding temperature, or ambient temperature. Optionally, the one or more sensors 114 can include a motor torque output sensor, a motor torque demand sensor, a motor rotational velocity sensor, demanded motor rotational velocity sensor, a motor voltage sensor, a motor current sensor, a motor drive frequency sensor, or a battery charge sensor.

The motor controller 106 can operate by receiving the parameters on the one or more parameter input lines 108a and/or 108b, optionally performing transformation or processing, and load the parameters (or transformed or processed parameters) into the memory 404. A process can be carried out by the microprocessor 402 (or optionally by a state machine (not shown)) to read the current parameter values from memory. The process can use the read parameter values in an algorithm, or optional to access a look-up table (LUT) or database to retrieve a motor cooler 104 drive parameter. For example, the parameter values can act as or be transformed to address values to access a LUT in the storage memory 406. An addressed data value then can be used to drive the motor cooler 104, or can be transformed or processed to drive the motor cooler 104. The motor cooler parameter determination process can be performed synchronously or asynchronously with parameter receipt on the parameter input lines 108a, 108b.

The controller 106 can be configured to select from among a plurality of discrete motor cooling apparatus 104 settings. Thus, driving the motor cooling apparatus 104 to minimize the sum of energy consumed by the motor plus energy consumed by the motor cooling apparatus 104 includes selecting from among the plurality of discrete motor cooling apparatus 104 settings.

According to some embodiments, the motor cooler 104 can be operated intermittently. For example, the motor cooler drive parameter can include a frequency or duty cycle with which the motor cooler 104 is turned on and off, or with which the motor cooler 104 is switched between cooling output values. The duty cycle and/or frequency can itself constitute the most efficient motor cooler drive. The controller 106 can be configured to periodically select from among the plurality of discrete motor cooling apparatus 104 settings. Minimizing the sum of energy consumed by the motor plus energy consumed by the motor cooling apparatus 104 can be performed by selecting a schedule for switching between two or more discrete motor cooling apparatus 104 settings.

Optionally, the controller 106 can be configured to allow short term non-maximal system efficiency (or equivalently, non-minimal energy consumption). For example, the controller 106 can be configured to increase cooling energy consumption in anticipation of future motor use or motive energy output.

Generally, the cooling energy consumption provided by the controller 106 can be neither directly proportional to motor rotational velocity (as in the case of a shaft-coupled fan), nor directly proportional to or a strict function of temperature, such as with a thermostatically controlled motor cooler. The motor cooling apparatus 104 is configured to cool the motor 102 via an operative coupling 112 that can take many forms, depending on the physical embodiments of the motor cooling apparatus 104 and the motor 102. As described above in conjunction with FIGS. 2A, 2B, the cooling energy consumption can include a plurality of discrete cooling energy consumptions rather than being infinitesimally adjustable. According to embodiments, the system efficiency is maximized by the controller 106 and the computer instructions carried in the storage device 406 compared to at least a second prospective cooling energy consumption. In other words, the sum of energy consumed by the motor plus energy consumed by the motor cooling apparatus is minimized compared to other available motor cooling apparatus energy consumptions. The system efficiency can be maximized compared to at least a second system efficiency with a cooling energy consumption that is driven proportional to motor rotational velocity or is thermostatically controlled to be on or off.

In other words, the sum of a motor energy consumption plus the cooler energy consumption, and the sum divided by a motor output energy greater than zero can be minimized compared to at least a second prospective sum of a motor energy consumption plus fixed cooler energy consumption, and the sum divided by the same motor output energy greater than zero. Equivalently, the sum of a motor energy consumption plus the cooler energy consumption, and the sum divided by a motor output energy greater than zero can be minimized compared to at least a second sum of motor energy consumption plus prospective cooler energy consumption that is driven proportional to motor rotational velocity or is thermostatically controlled to be on or off, and the sum divided by the same motor output energy greater than zero.

Optionally, the controller 106 can include one or more relays, solenoids, valves, or a combination thereof (not shown) configured to actuate the motor cooling apparatus 104. Optionally, the storage memory 406 can receive programming corresponding to a desired controller 106 behavior. For example, the controller 106 can operate by dynamically receiving programming corresponding to a relatively slow-changing operating level or operating condition, and then respond to faster changing inputs using the approaches described herein.

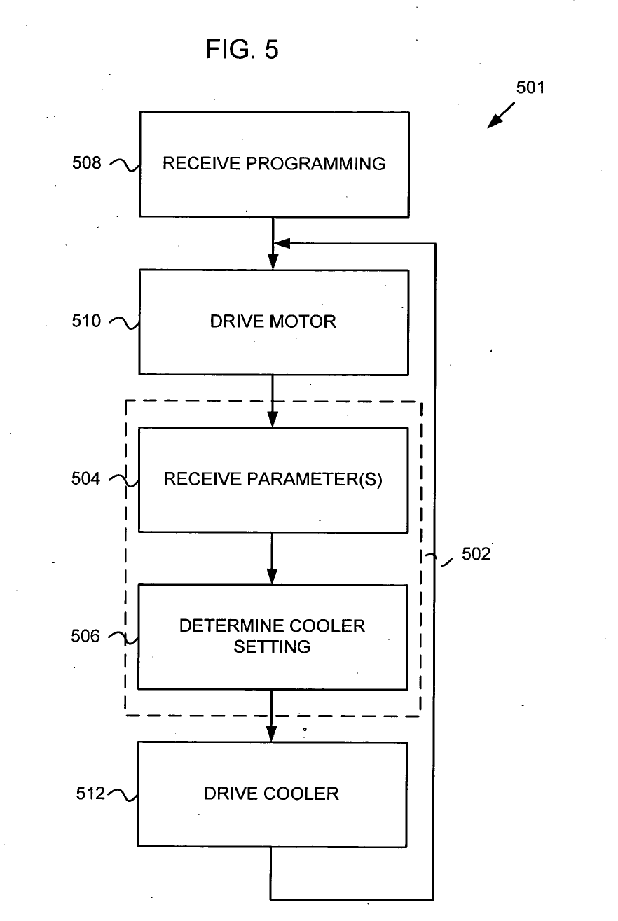

FIG. 5 is a flow chart showing a method 501 for operating a motor and a motor cooling apparatus to maximize system efficiency, according to an embodiment. Optionally, the method 501 can include or substantially consist of a method or method portion 502 including two steps 504 and 506, described more fully below.

Optionally, the method 501 can include additional steps of receiving programming in step 508, driving a motor in step 510, and driving a motor cooler in an optimized way in step 512. Receiving programming in step 508 can include receiving instructions to select an operational mode. Optionally, receiving programming in step 508 can include receiving a relationship between a motor cooling apparatus parameter and a received parameter corresponding to a motor operational value.

Driving a motor in step 510 can include driving an electric motor such as an AC induction motor, a universal motor, an AC synchronous motor, a DC stepper motor, a DC brushless motor, a DC brushed motor, or a pancake DC motor.

The method or method portion 502 can include receiving one or more parameters in step 504. For example, step 504 can include receiving at least a first parameter corresponding to or predictive of an operational value of a motor. Receiving at least a first parameter in step 504 can include operating a sensor. For example, the sensor can include a temperature sensor configured to measure one or more of motor temperature, motor winding temperature, or ambient temperature. Optionally, operating a sensor can include operating one or more of a motor torque output sensor, a motor torque demand sensor, a motor rotational velocity sensor, demanded motor rotational velocity sensor, a motor voltage sensor, a motor current sensor, a motor drive frequency sensor, or a battery charge sensor.

Alternatively or additionally, receiving at least one first parameter corresponding to or predictive of an operational value of a motor can include receiving signal or data across an interface. For example, receiving at least a first parameter can include receiving a signal or data from a motor control system. As with embodiments where step 504 includes operating one or more sensors, receiving the at least one first parameter across an interface can include receiving one or more of motor temperature, motor winding temperature, or ambient temperature. According to embodiments, receiving at least a first parameter can include receiving one or more of a motor torque output, a motor torque demand, a motor rotational velocity, a demanded motor rotational velocity, a motor drive voltage, a motor current, a motor drive frequency, or a battery charge.

Optionally, receiving at least a first parameter corresponding to or predictive of an operational value of the motor can include receiving one or more of a future motor torque demand or a future demanded motor rotational velocity.

Proceeding to step 506, at least a second parameter corresponding to driving a motor cooling apparatus can be determined as a function of the first parameter. The second parameter can be selected to minimize a combination of energy consumed by the motor cooling apparatus plus energy lost by motor inefficiency corresponding to the operational value.

Depending on the physical embodiment of the motor cooling apparatus, the second parameter or parameters can take various forms. For example, the motor cooling apparatus includes one or more of a fan, a circulating liquid, a phase-change fluid, a vapor-compression refrigeration device, a vapor-absorption refrigeration device, Peltier-effect device, or a caloric effect device. The second parameter can include an amount of cooling or can include a cooling device drive parameter. For example, in the case of a fan, the second parameter can include a fan motor current, a number of fans to drive, or a duty cycle with which the fan (or fans) is switched on or off. Alternatively, the second parameter can include parameters for selectively driving a plurality of motor cooling apparatuses.

The available second parameters can comprise a plurality of discrete motor cooling apparatus settings. Determining a cooler setting in step 606 can include determining with a computer at least a second parameter corresponding to driving a motor cooling apparatus includes selecting from among a plurality of discrete motor cooling apparatus settings. Selecting from among a plurality of discrete motor cooling apparatus settings can include periodically selecting from among the plurality of discrete motor cooling apparatus settings. Thus, the second parameter can include a schedule for switching between two or more discrete motor cooling apparatus settings.

According to embodiments, receiving, in step 504, at least a first parameter corresponding to or predictive of a motor operational level can include receiving at least two first parameters. Determining (for example, with a computer) at least a second parameter corresponding to driving a motor cooling apparatus can include determining the second parameter as a function of the at least the two first parameters.

Optionally, a second parameter(s) corresponding to driving a motor cooling apparatus can include allowing a short term non-minimal combination of energy consumed by the motor cooling apparatus plus energy lost by motor inefficiency corresponding to the temperature. For example, step 506 can include determining a temporary second parameter corresponding to increased energy consumed by the motor cooling apparatus in anticipation of future motor use.

Generally, the second parameter is not directly proportional to motor rotational velocity and is not directly proportional to temperature.

The one or more second (motor cooling apparatus) parameter(s) determined in step 506 can be determined such that the combination of energy consumed by the motor cooling apparatus plus energy lost by motor inefficiency corresponding to the temperature is minimized compared to other available second parameters. The combination of energy consumed by the motor cooling apparatus plus energy lost by motor inefficiency corresponding to the temperature can be minimized when the combined energy lost by motor inefficiency and the energy consumed by the motor cooling apparatus is less than the combined energy lost by motor inefficiency and the energy consumed by the motor cooling apparatus under conditions of the second parameter being proportional to motor rotational velocity or the second parameter corresponding to a thermostatic function of the first parameter. In other words, the combination of energy consumed by the motor cooling apparatus plus energy lost by motor inefficiency corresponding to the temperature can be minimized when combination of energy consumed by the motor cooling apparatus plus energy lost by motor inefficiency corresponding to the temperature is within a tolerance of a prospective minimum consumption to achieve a non-zero motive energy output. For example, the tolerance can be 10%.

The method 501 can include a step 510 of driving a motor to produce a specified motor performance, and a step 512 of driving a motor cooling apparatus to minimize a sum of energy consumed by the motor plus energy consumed by the motor cooling apparatus. The motor cooling apparatus can be driven based on a function of the specified motor performance.

Optionally, at least portions of the method(s) shown and described above can be embodied as computer instructions carried on a non-transitory computer readable medium, wherein the instructions can cause a computer to execute the steps of the method(s).

While particular aspects of the present subject matter described herein have been shown and described, it will be apparent that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1-96. (canceled)

97. A system for cooling a motor, comprising:
a motor cooling apparatus configured to cool a motor; and
a controller including an interface configured to receive a parameter corresponding to, or predictive of, a motor operational value, the controller being operatively coupled to the motor cooling apparatus and configured to drive the motor cooling apparatus to minimize a sum of energy consumed by the motor plus energy consumed by the motor cooling apparatus.

98. The system for cooling a motor of claim 97, wherein the motor operational value comprises a motor temperature.

99. The system for operating a motor of claim 97, wherein the motor operational value comprises one or more of motor work output, motor torque output, motor torque demand, motor rotational velocity, demanded motor rotational velocity, motor voltage, motor current, motor drive frequency, battery charge, power availability, or an incremental energy cost.

100. The system for cooling a motor of claim 97, wherein the motor cooling apparatus includes one or more of a fan, a circulating liquid, a phase-change fluid, a vapor-compression refrigeration device, a vapor-absorption refrigeration device, Peltier-effect device, or a caloric effect device.

101. The system for cooling a motor of claim 97, wherein the controller further includes one or more relays, solenoids, valves, or a combination thereof configured to actuate the motor cooling apparatus.

102. The system for cooling a motor of claim 97, further comprising:
a sensor operatively coupled to the interface and configured to detect the parameter corresponding to or predictive of the motor temperature.

103. The system for cooling a motor of claim 102, wherein the sensor includes a temperature sensor configured to measure one or more of motor temperature, motor winding temperature, or ambient temperature.

104. The system for cooling a motor of claim 102, wherein the motor temperature corresponds to the motor winding temperature.

105. The system for cooling a motor of claim 102, wherein the sensor includes one or more of a motor torque output sensor, a motor torque demand sensor, a motor rotational velocity sensor, demanded motor rotational velocity sensor, a motor voltage sensor, a motor current sensor, a motor drive frequency sensor, or a battery charge sensor.

106. The system for cooling a motor of claim 97, wherein the interface includes an interface configured to receive a signal or data.

107. The system for cooling a motor of claim 106, wherein the interface is configured to receive a signal or data from a motor control system.

108. The system for cooling a motor of claim 97, wherein the interface is configured to receive one or more of a future motor torque demand or a future demanded motor rotational velocity.

109. The system for cooling a motor of claim 97, wherein the interface is configured to receive at least two parameters and the controller is configured to drive the motor cooling apparatus responsive to the at least two parameters.

110. The system for cooling a motor of claim 97, wherein the controller is programmable.

111. The system for cooling a motor of claim 97, wherein the controller is configured to allow short term non-minimal sum of energy consumption.

112. The system for cooling a motor of claim 97, wherein the controller is configured to increase energy consumed by the motor cooling apparatus in anticipation of future motor use.

113. The system for cooling a motor of claim 97, wherein the energy consumed by the motor cooling apparatus is not directly proportional to motor rotational velocity.

114. The system for cooling a motor of claim 97, wherein the energy consumed by the motor cooling apparatus is not directly proportional to temperature.

115. The system for cooling a motor of claim 97, wherein the sum of energy consumed by the motor plus energy consumed by the motor cooling apparatus energy consumption is minimized compared to other available motor cooling apparatus energy consumptions.

116. The system for cooling a motor of claim 113, wherein the available motor cooling apparatus energy consumptions comprise a plurality of discrete motor cooling apparatus settings.

117. The system for cooling a motor of claim 97, wherein the controller is configured to select from among a plurality of discrete motor cooling apparatus settings; and
wherein driving the motor cooling apparatus to minimize the sum of energy consumed by the motor plus energy consumed by the motor cooling apparatus includes selecting from among the plurality of discrete motor cooling apparatus settings.

118. The system for cooling a motor of claim 117, wherein the controller is configured to periodically select from among the plurality of discrete motor cooling apparatus settings.

119. The system for cooling a motor of claim 118, wherein the controller is configured to minimize the sum of energy consumed by the motor plus energy consumed by the motor cooling apparatus by selecting a schedule for switching between two or more discrete motor cooling apparatus settings.

120. The system for cooling a motor of claim 97, wherein the sum of energy consumed by the motor plus energy consumed by the motor cooling apparatus is minimized when combined energy consumed by the motor and the motor cooling apparatus is less than combined energy consumed by the motor and the motor cooling apparatus under conditions of the motor cooling apparatus being driven proportional to motor rotational velocity or the motor cooling apparatus being thermostatically controlled to be on or off.

121. The system for cooling a motor of claim 97, wherein the sum of energy consumed by the motor plus energy consumed by the motor cooling apparatus is minimized when combined energy consumed by the motor and the motor cooling apparatus is within a tolerance of a prospective minimum consumption to achieve the non-zero motive energy output.

122. The system for cooling a motor of claim 121, wherein the tolerance is 10%.

123. The system for cooling a motor of claim 97, further comprising a motor.

124. The system for cooling a motor of claim 97, wherein the motor is an electric motor.

125. The system for cooling a motor of claim 97, wherein the motor is an AC induction motor, a universal motor, an AC synchronous motor, a DC stepper motor, a DC brushless motor, a DC brushed motor, or a pancake DC motor.

126-155. (canceled)

156. A computer method for determining optimized cooling of a motor, comprising:
receiving at least a first parameter corresponding to or predictive of an operational value of a motor; and
determining with a computer at least a second parameter corresponding to driving a motor cooling apparatus as a function of the first parameter;
wherein the second parameter is selected to minimize a combination of energy consumed by the motor cooling apparatus plus energy lost by motor inefficiency corresponding to the operational value.

157. The computer method for determining optimized cooling of a motor of claim 156, wherein the motor cooling apparatus includes one or more of a fan, a circulating liquid, a phase-change fluid, a vapor-compression refrigeration device, a vapor-absorption refrigeration device, Peltier-effect device, or a caloric effect device.

158. The computer method for determining optimized cooling of a motor of claim 156, wherein receiving at least a first parameter corresponding to or predictive of a motor operational value includes operating a sensor.

159. The computer method for determining optimized cooling of a motor of claim 158, wherein the sensor includes a temperature sensor configured to measure one or more of motor temperature, motor winding temperature, or ambient temperature.

160. The computer method for determining optimized cooling of a motor of claim 158, wherein the sensor measures a motor winding temperature.

161. The computer method for determining optimized cooling of a motor of claim 158, wherein the sensor includes one or more of a motor work output sensor, a motor torque output sensor, a motor torque demand sensor, a motor rotational velocity sensor, demanded motor rotational velocity sensor, a motor voltage sensor, a motor current sensor, a motor drive frequency sensor, or a battery charge sensor.

162. The computer method for determining optimized cooling of a motor of claim 156, wherein receiving at least a first parameter corresponding to or predictive of a motor operational value includes receiving signal or data across an interface.

163. The computer method for determining optimized cooling of a motor of claim 156, wherein receiving at least a first parameter corresponding to or predictive of a motor operational value includes receiving a signal or data from a motor control system.

164. The computer method for determining optimized cooling of a motor of claim 156, wherein receiving at least a first parameter corresponding to or predictive of a motor operational value includes receiving one or more of motor temperature, motor winding temperature, or ambient temperature.

165. The computer method for determining optimized cooling of a motor of claim 156, wherein receiving at least a first parameter corresponding to or predictive of a motor operational value includes receiving one or more of a motor work output, motor torque output, a motor torque demand, a motor rotational velocity, a demanded motor rotational velocity, a motor drive voltage, a motor current, a motor drive frequency, or a battery charge.

166. The computer method for determining optimized cooling of a motor of claim 156, wherein receiving at least a first parameter corresponding to or predictive of a motor operational value includes receiving one or more of a future motor torque demand or a future demanded motor rotational velocity.

167. The computer method for determining optimized cooling of a motor of claim 156, wherein receiving at least a first parameter corresponding to or predictive of a motor operational value includes receiving at least two first parameters; and
wherein determining with a computer at least a second parameter corresponding to driving a motor cooling apparatus includes determining the second parameter as a function of the at least the two first parameters.

168. The computer method for determining optimized cooling of a motor of claim 156, further comprising:
receiving programming to select an operation mode.

169. The computer method for determining optimized cooling of a motor of claim 156, wherein determining with a computer at least a second parameter corresponding to driving a motor cooling apparatus includes allowing a short term non-minimal combination of energy consumed by the motor cooling apparatus plus energy lost by motor inefficiency corresponding to the temperature.

170. The computer method for determining optimized cooling of a motor of claim 156, further comprising:
determining a temporary second parameter corresponding to increased energy consumed by the motor cooling apparatus in anticipation of future motor use.

171. The computer method for determining optimized cooling of a motor of claim 156, wherein the second parameter is not directly proportional to motor rotational velocity.

172. The computer method for determining optimized cooling of a motor of claim 156, wherein the second parameter is not directly proportional to temperature.

173. The computer method for determining optimized cooling of a motor of claim 156, wherein the combination of energy consumed by the motor cooling apparatus plus energy lost by motor inefficiency corresponding to the temperature is minimized compared to other available second parameters.

174. The computer method for determining optimized cooling of a motor of claim 173, wherein the available second parameters comprise a plurality of discrete motor cooling apparatus settings.

175. The computer method for determining optimized cooling of a motor of claim 156, wherein determining with a computer at least a second parameter corresponding to driving a motor cooling apparatus includes selecting from among a plurality of discrete motor cooling apparatus settings.

176. The computer method for determining optimized cooling of a motor of claim 174, wherein selecting from among a plurality of discrete motor cooling apparatus settings includes periodically selecting from among the plurality of discrete motor cooling apparatus settings.

177. The computer method for determining optimized cooling of a motor of claim 156, wherein the second parameter includes a schedule for switching between two or more discrete motor cooling apparatus settings.

178. The computer method for determining optimized cooling of a motor of claim 156, wherein the combination of energy consumed by the motor cooling apparatus plus energy lost by motor inefficiency corresponding to the temperature is minimized when the combined energy lost by motor inefficiency and the energy consumed by the motor cooling apparatus is less than the combined energy lost by motor inefficiency and the energy consumed by the motor cooling apparatus under conditions of the second parameter being proportional to motor rotational velocity or the second parameter corresponding to a thermostatic function of the first parameter.

179. The computer method for determining optimized cooling of a motor of claim 156, wherein the combination of energy consumed by the motor cooling apparatus plus energy lost by motor inefficiency corresponding to the temperature is minimized when combination of energy consumed by the motor cooling apparatus plus energy lost by motor inefficiency corresponding to the temperature is within a tolerance of a prospective minimum consumption to achieve a non-zero motive energy output.

180. The computer method for determining optimized cooling of a motor of claim 178, wherein the tolerance is 10%.

181. The computer method for determining optimized cooling of a motor of claim 156, wherein the motor is an electric motor.

182. The computer method for determining optimized cooling of a motor of claim 156, wherein the motor is an AC induction motor, a universal motor, an AC synchronous motor, a DC stepper motor, a DC brushless motor, a DC brushed motor, or a pancake DC motor.

183-209. (canceled)
